(19) United States
(12) Patent Application Publication
(10) Pub. No.: US 2003/0002682 A1
(43) Pub. Date: Jan. 2, 2003

(54) Wireless audio/mechanical vibration transducer and audio/visual transducer

(75) Inventors: Godorn Smith, Sandy, UT (US); David W. Thorson, S.L.C., UT (US)

Correspondence Address: Lloyd W. Sadler, MCCARTHY & SADLER, LC, Suite 100, 39 Exchange Place, Salt Lake City, UT, 84111, US

(73) Assignee: Phonex Broadband Corporation

(21) Appl. No.: 09/898,156

(22) Filed: Jul. 2, 2001

(51) Int. Cl. H04H 5/00

(52) U.S. Cl. 381/2

(57) ABSTRACT

An audio/mechanical/visual transducer system that makes use of a wireless communication channel for communicating between the audio signal generator and the transducer, through a wireless transmitter is provided. This invention provides an RF or Power Line Carrier path for communicating the audio signals to a variety of transducer devices, thereby permitting maximum positional flexibility for the transducers without requiring additional or dedicated wiring.

### BACKGROUND OF INVENTION

1. Field of the Invention

This invention relates devices for converting audio signals into mechanical vibrations and/or visual displays. More specifically, this invention relates to devices for converting audio signals into mechanical vibrations and/or visual displays which make use of a wireless radio frequency or power line carrier channel.

2. Description of Related Art

A variety of transducers, which convert electrical signals into mechanical vibrations or light displays have been proposed. Generally however, these systems require a wired connection between the signal source and the mechanical vibration or light-generating device.

The reader is directed to the following U.S. patent documents for general background material. Each of these patens is hereby incorporated by reference in its entirety for the material contained therein.

U.S. Pat. No. 3,747,054 describes a control apparatus, which includes an encoder-transmitter section having a plurality of fixed frequency oscillators generating a plurality of electrical control signals at different alternating current frequencies, and a transmitting transducer connected to receive said control signals and mounted on the outside of pipeline for converting said electrical control signals to mechanical signals.

U.S. Pat. No. 3,790,891 describes a receiver for a frequency-modulation electro-acoustical signal system and more particularly to a compression wave transmission system having a receiver which is adapted to suppress noise signals of frequencies other than the frequencies of the electro-acoustical frequencies, only during periods when no electro-acoustical of compression wave frequency is received.

U.S. Pat. No. 4,038,634 describes a warning system for installation in a vehicle that includes a transducer located at a selected location in the vehicle to detect specific conditions.

U.S. Pat. No. 4,207,568 describes a method and apparatus for underwater communication, comprising two dipoles disposed in a common body of water.

U.S. Pat. No. 4,471,258 describes a transducer that includes at least a piezoelectric ceramic plate, which has curved surfaces, electrodes, which are formed on both the main surfaces of the piezoelectric ceramic plate, a frame which holds the piezoelectric ceramic plate, and a means for applying an electric signal to the electrodes.

U.S. Pat. No. 4,493,101 describes an anti-howl back device, which includes various devices and a CPU that controls these devices, their decisions, and their processing in order to output the signals, which are fed into a selector circuit upon removal of acoustic feedback components.

U.S. Pat. No. 4,864,610 describes an earpiece for use with a post-auricle communication headset.

U.S. Pat. No. 4,951,410 describes a fish attractor that uses an electronically driven acoustic sounder.

U.S. Pat. No. 5,035,247 describes a sensor for non-invasive measurement of sound, pressure and vibration on the human body.

U.S. Pat. No. 5,051,799 describes a digital output transducer, contained within a single housing, for receiving an acoustic signal, an analog-to-digital converter for changing the output of the transducer into a series of digital pulses representing the incoming acoustic signal.

U.S. Pat. No. 5,186,629 describes a computer mouse having tactile feedback to be used with an audio computer output to provide a virtual graphic display to blind computer users.

U.S. Pat. No. 5,335,186 describes an apparatus for intelligent programmable sensing using elements mounted on a silicon base that comprises a silicon sensor transducer and a configurable analog signal conditioner.

U.S. Pat. No. 5,338,287 describes an electromagnetic induction type hearing aid.

U.S. Pat. No. 5,724,312 describes an ultrasound transducer head that contains at least one transducer element, which receives ultrasound signals and converts them into electrical receive signals.

U.S. Pat. No. 5,737,433 describes a sound environment control apparatus that allows a user to selectively suppress any or all of multiple noises in his or her environment, or selectively listen to any of these while suppressing all other sound.

U.S. Pat. No. 5,771,441 describes a portable RF transmitter having an audio plug extending there from which mates with the earphone or output jack of an audio source such as a portable battery operated CD or tape player and having no external antenna.

U.S. Pat. No. 5,951,500 describes an audio-responsive massage system that includes a pad for contacting a user of the system.

U.S. Pat. No. 5,966,655 describes an automatic method for determining of an audio or vibration alerting for an incoming call in a wireless handset.

U.S. Pat. Nos. 5,982,297 and 6,037,704 describe a system for ultrasonic data communication system, that includes a first transducer and a second transducer coupled together through a coupling medium.

U.S. Pat. No. 5,992,237 describes a vibration-coupling stud for use in a vibration monitoring system that includes digital memory and temperature sensing devices.

U.S. Pat. No. 6,01 0,532 describes a dual path implantable hearing assistance system that transduces sound vibrations of the malleus in one or both ears into electrical signals.

U.S. Pat. No. 6,058,305 describes a PCS switching system and wireless set that allows the wireless set to control the processing of incoming calls regardless of whether the base station on which the wireless set is registered has capacity to complete a call to the wireless set.

### SUMMARY OF INVENTION

It is desirable to provide an audio/mechanical vibration transducer for converting sound signals into mechanical vibrations that are felt by a user. It is particularly desirable to provide an audio/mechanical vibration transducer, which does not require dedicated wiring to communicate the audio signal from the signal source to the transducer.

Accordingly, it is an object of this invention to provide a wireless audio/mechanical vibration transducer that is compatible with either a power line or an over the air RF communication channel.

It is another object of this invention to provide a wireless audio/mechanical vibration transducer, which permits the transducer to be placed a significant distance from the signal source without requiring dedicated wiring.

It is a further object of this invention to provide a wireless audio/mechanical vibration transducer, which is compatible with multi-channel audio and audio/video systems.

Another object of this invention is to provide a wireless audio/mechanical vibration transducer, which converts audio signals from an audio signal source to visual signals such as lights, moving pictures and/or dynamic designs.

A still further object of this invention is to provide a wireless audio/mechanical vibration transducer wherein an AC power line or RF channel provides the path for the audio signal to the transducer.

A further object of this invention is to provide a wireless audio/mechanical vibration transducer, which is compatible with multiple transducer use.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described the preferred embodiment of this invention. As it will be realized, this invention is capable of other different embodiments, and its several details and specific circuitry, are capable of modification in various aspects without departing from the invention. Accordingly, the objects, drawings and descriptions in this disclosure should be regarded as illustrative in nature and not as restrictive.

### BRIEF DESCRIPTION OF DRAWINGS

The accompanying drawings incorporated in and forming a part of the specification, illustrate a preferred embodiment of the present invention. Some, although not all, alternative embodiments are described in the following description. In the drawings:

FIG. 1 is a block diagram of the preferred transducer communication system of this invention.

Reference will now be made in detail to the present preferred embodiment of the invention, an example of which is illustrated in the accompanying drawings.

### DETAILED DESCRIPTION

This invention is an audio and mechanical vibration transducer adapted to receive audio signals without requiring dedicated wiring, that is by making use of a Radio Frequency (RF) over-the-air or Power Line Carrier (PLC) communication channel. For the purposes of this patent disclosure either of these communication channels is defined as “wireless.” By adapting wireless communications to an audio/mechanical vibration transducer, this invention facilitates the use of the transducer that can be placed at some distance from the audio transmitter, which typically requires an AC power connection, by not requiring additional or dedicated wiring.

An audio/mechanical vibration transducer is a device that is used to present the “feel” of sound to a user. As the audio signals from an audio source, such as but not necessarily limited to a stereo, a compact disk player, a television, a home entertainment system, a theater system, are transmitted, the transducer converts the received signals into mechanical vibrations that can be felt by the user. The transducer can be placed under a cushion or pillow of a couch, chair or bed. The system of this invention can be used in conjunction with both any standard stereo system as well as multi-channel audio systems. In its preferred embodiment this invention has very low frequency response as is appropriate for transducer activation.

This invention is also able to convert the received audio signals to drive, activate or control such visual displays as lights, moving pictures and dynamic designs.

As noted above, this invention uses PLC or over-the-air RF technology to provide a communication channel for the mechanical and visual transducers in order to permit the placement of the transducers at a distance from the audio signal source without requiring additional or dedicated wiring between the source and the transducers.

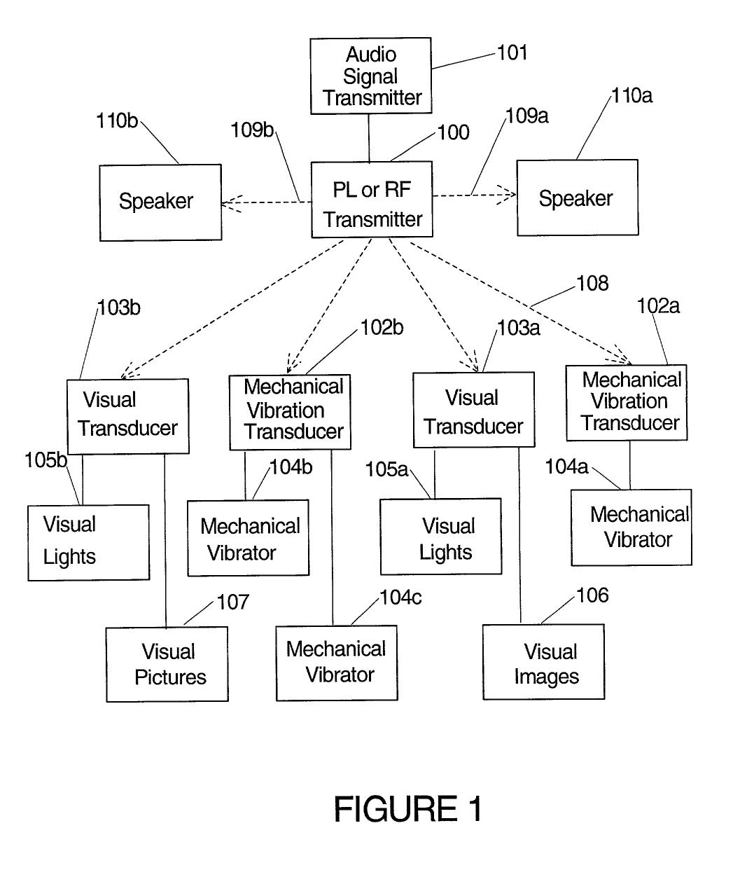

FIG. 1 shows a block diagram of the preferred transducer communication system of this invention. The audio signals are provided by an audio signal transmitter 101 that is either coupled to the AC power line or to an RF antenna (either of which for the purposes of this patent disclosure are referred to as “wireless transmitter”) for transmission 108 to the transducers 102a, 102b, 103a, 103b. The transducers 102a, 102b, 103a, 103b receive the audio signals from the wireless transmitter 100 and convert these signals to either mechanical vibration signals for one or more mechanical vibrators 104a, 104b or visual signal drivers 105a, 105b, 106, 107. As can be seen from this drawing, a variety of different visual signal drivers are supported by this invention, including but not necessarily limited to visual lights 105a, 105b, visual pictures 107, and visual images 106. For the purposes of this disclosure the term “actuator” shall be interpreted to include one or more of the mechanical vibrators, visual signal drivers and audio speakers. Multiple transducers can be connected to a single transducer and a combination of mechanical transducers only, visual transducers only or mechanical and visual transducers are supported. Since both the mechanical and visual transducers generally use low frequencies, they are provided with an input filter to limit the band of frequencies permitted and to minimize signal noise. The wireless transmitter 100 is also compatible with use with wireless speakers 110a, 110b, which also typically uses an RF over-the-air or power line communication channel 109a, 109b.

The previously described preferred embodiment of this invention is to be considered in all respects only as illustrative and not as restrictive. Although the embodiment shown here describes specific components and subsections of the preferred embodiment, the invention is not limited thereto. The scope of this invention is indicated by the appended claims rather than by the foregoing description. All devices and systems, which come directly within the claims or within the meaning and range of equivalency of the claims, are to be embraced as being within the scope of this patent.

1. A wireless audio transducer system, comprising:
(A) a wireless transmitter;
(B) a wireless transducer in electromagnetic communication with said wireless transmitter; and
(C) an actuator for converting signals received from said wireless transducer to sensor input.

2. A wireless audio transducer system, as recited in claim 1, further comprising:
(D) an audio signal transmitter.

3. A wireless audio transducer system, as recited in claim 1, wherein said wireless transmitter is an RF over-the-air transmitter.

4. A wireless audio transducer system, as recited in claim 1, wherein said wireless transmitter is a power line carrier transmitter.

5. A wireless audio transducer system, as recited in claim 1, wherein said actuator is a visual display driver.

6. A wireless audio transducer system, as recited in claim 1, wherein said actuator is a mechanical vibrator.

7. A wireless audio transducer system, as recited in claim 5, wherein said visual display driver provides signals for visual lights.

8. A wireless audio transducer system, as recited in claim 5, wherein said visual display driver provides signals for visual pictures.
